(19) United States
(12) Patent Application Publication
(10) Pub. No.: US 2025/0223469 A1
(43) Pub. Date: Jul. 10, 2025

(54) SOLVENT COMPOSITION, ADHESIVE FORMULATION, AND METHOD FOR BONDING SURFACE

(71) Applicant: UNIVERSITY OF MASSACHUSETTS, Westborough, MA (US)

(72) Inventor: Gregory MOROSE, Haverhill, MA (US)

(21) Appl. No.: 18/851,516

(22) PCT Filed: Mar. 29, 2023
(86) PCT No.: PCT/US2023/016654

§ 371 Date: Sep. 26, 2024

Related U.S. Application Data
(60) Provisional application No. 63/325,695, filed on Mar. 31, 2022.

(51) Int. Cl. C09J 5/02; C08J 5/12; C09J 127/06

(52) U.S. Cl. CPC C09J 5/02; C08J 5/122; C08J 5/124; C09J 127/06; C08J 2327/06; C09J 2427/00

(57) ABSTRACT

A composition includes particular amounts of a first solvent selected from benzaldehyde, 1,3-dioxolane, tetrahydropy-ran, 4-picoline, ethyl benzoate, methyl benzoate, or a combination thereof; a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof. The solvent composition can be particularly useful in adhesive formulations such as solvent cements.

### CROSS REFERENCE TO RELATED APPLICATION

This application claims priority to U.S. Provisional Application No. 63/325,695, filed Mar. 31, 2022, the contents of which are hereby incorporated by reference in their entirety.

### BACKGROUND

Tetrahydrofuran (THF) and N-methylpyrrolidone (NMP) are commonly used as primary solvent ingredients for poly vinyl chloride (PVC) cements, PVC primers, chlorinated poly vinyl chloride (CPVC) cements, CPVC primers, and PVC adhesives. These products are used to create an adhesive bond between separate PVC or CPVC articles, such as pipes, fittings, and flanges. The adhesive can also contain thermoplastic resin of either PVC or CPVC dissolved in the solvent blend, thus creating a cement. The thermoplastic resin is typically the same as the thermoplastic to be joined but can also include other types of resins and polymers, such as acrylic resins, vinyl aromatic polymers, and vinyl pyrrolidone polymers, to meet specific product application requirements.

The article surfaces to be joined are typically first coated with a primer that consists of a solvent blend. The primer partially dissolves or softens the surface, which enables the solvent cement better penetration to generate a more effective adhesive bond. The cement is then applied to the article surfaces to be joined. The cement consists of a solvent blend and the thermoplastic to be bonded. The cement further partially dissolves or softens the surface of the article. Once the solvents in the cement evaporate, an adhesive bond is created between the PVC or CPVC articles.

The current marketplace is dominated by PVC cements, PVC primers, CPVC cements, CPVC primers products containing THF, and PVC adhesives containing NMP. With the exception of NMP, the solvents used in current commercial formulations can evaporate quickly. For example, common solvents and their relative evaporation rates include: THF (472), methyl ethyl ketone (380), cyclohexanone (29), and acetone (630). In contrast, NMP evaporates slowly with a relative evaporation rate of 3 (which can lead to long cure times, e.g., greater than 24 hours).

There are human health and safety issues for users of these products containing THF and NMP ingredients. The U.S. Environmental Protection Agency (EPA), European Chemicals Agency (ECHA), and California Environmental Protection Agency have classified NMP with developmental toxicity. THF has recently been designated as a carcinogen by the International Agency for Research on Cancer (IARC) and California EPA. These solvents (e.g. THF and NMP) in these products evaporate during use and potentially expose the user to chemicals that are carcinogens or toxic to reproduction/development.

Accordingly, there remains a continuing need for cement or adhesive formulations without carcinogens or chemicals toxic to reproduction and/or development. It would be a further advantage to provide a nontoxic product that also exhibits fast cure times.

### BRIEF SUMMARY

A composition comprises a first solvent selected from benzaldehyde, 1,3-dioxolane, tetrahydropyran, 4-picoline, ethyl benzoate, methyl benzoate, or a combination thereof, preferably wherein the first solvent is present in an amount of 1 to 80 volume percent, based on the total volume of the composition; a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof, preferably wherein the second solvent is present in an amount of 10 to 85 volume percent, based on the total volume of the composition; wherein the amounts of the first solvent, and the second solvent, sum to at least 90 volume percent.

A method for the manufacture of the composition comprises combining first solvent and the second solvent to provide the composition.

An adhesive formulation comprises 1 to 25 volume percent, or 5 to 15 volume percent, of a thermoplastic resin, preferably a polyvinyl chloride, a chlorinated poly vinyl chloride, acrylonitrile-butadiene-styrene (ABS), or a combination thereof, and 75 to 99 volume percent, or 85 to 95 volume percent, of the solvent composition, wherein volume percent is based on the total volume of the adhesive formulation.

A method for bonding a first plastic component to a second plastic component comprises applying the adhesive formulation to at least a portion of a surface of the first and/or second plastic component: and contacting the surface of the first plastic component with a surface of the second plastic component.

A method for bonding a first plastic component to a second plastic component comprises applying a primer composition to at least a portion of a surface of the first plastic component, at least a portion of a surface of the second plastic component, or both, wherein the primer composition comprises, based on the total volume of the composition, a first solvent selected from benzaldehyde, 1,3-dioxolane, tetrahydropyran, 4-picoline, ethyl benzoate, methyl benzoate, or a combination thereof, preferably wherein the first solvent is present in an amount of 1 to 80 volume percent, based on the total volume of the composition; a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof, preferably wherein the second solvent is present in an amount of 10 to 85 volume percent, based on the total volume of the composition; wherein the amounts of the first solvent, and the second solvent, sum to at least 90 volume percent: applying an adhesive composition comprising a thermoplastic resin to at least a portion of a surface of the first plastic component, at least a portion of a surface of the second plastic component, or both; and contacting the surface of the first plastic component with a surface of the second plastic component.

These and other aspects are described in detail below.

### DETAILED DESCRIPTION

The present inventor has discovered formulations without chemicals that are carcinogens or toxic to reproduction/development. Specifically, it has now been discovered that there are certain solvents that can be used as replacements for tetrahydrofuran (THF) and N-methylpyrrolidone (NMP) in solvent-based formulations, for example for primer, cement, adhesive formulations, and the like (e.g., PVC cements, PVC primers, CPVC cements, CPVC primers, and PVC adhesive products).

Accordingly, an aspect of the disclosure is a composition. The composition comprises a particular combination of solvents. Specifically, the composition comprises a first solvent selected from benzaldehyde, 1,3-dioxolane, tetrahydropyran, 4-picoline, ethyl benzoate, methyl benzoate, or a combination thereof. In an aspect, the first solvent can exhibit a relative evaporation rate (RER) of less than 80, relative to n-butyl acetate, wherein the RER of n-butyl acetate is 100.

The composition further comprises a second solvent selected from cyclic ketones (e.g., cyclopentanone, cyclohexanone, or cycloheptanone), aliphatic ketones (e.g., acetone, acetyl acetone, methyl ethyl ketone (MEK), 2-pentanone (MPK), or 3-pentanone/diethyl ketone (DEK)), methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof. In an aspect, the second solvent can be selected from cyclic ketones (e.g., cyclopentanone, cyclohexanone, or cycloheptanone), aliphatic ketones (e.g., acetone, acetyl acetone, methyl ethyl ketone (MEK), 2-pentanone (MPK), or 3-pentanone/diethyl ketone (DEK)), or a combination of any of the foregoing ketone solvents. In an aspect, the second solvent can exhibit a relative evaporation rate (RER) of 80 to 300, or 100 to 250, relative to n-butyl acetate, wherein the RER of n-butyl acetate is 100. For example, the second solvent can be selected from the cyclic ketones or aliphatic ketones, and can exhibit a RER of 80 to 300, or 100 to 250, relative to n-butyl acetate, wherein the RER of n-butyl acetate is 100.

In an aspect, the second solvent can comprise a solvent selected to modify the formulation to meet application-specific requirements. For example, in order to meet VOC exemption regulatory requirements, the second solvent can be methyl acetate, dimethyl carbonate, tert butyl acetate, propylene carbonate, PCBTF, or a combination thereof. Ethyl acetate, 1,2-butylene oxide, or a combination thereof can be selected to provide formulation stability. In an aspect, the second solvent can comprise methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof. In an aspect, the second solvent can exhibit a relative evaporation rate (RER) of greater than 300, relative to n-butyl acetate, wherein the RER of n-butyl acetate is 100.

The first solvent can be present in the composition in an amount of 1 to 80 volume percent, based on the total volume of the composition. Within this range, the first solvent can be present in an amount of 5 to 80 volume percent, or 10 to 80 volume percent, or 20 to 75 volume percent, or 25 to 70 volume percent, or 30 to 70 volume percent, or 30 to 65 volume percent, or 35 to 65 volume percent, or 40 to 65 volume percent, or 40 to 70 volume percent, or 40 to 80 volume percent, or 55 to 65 volume percent, each based on the total volume of the composition.

The second solvent can be present in the composition in an amount of 10 to 85 volume percent, based on the total volume of the composition. Within this range, the second solvent can be present in an amount of 10 to 80 volume percent, or 15 to 85 volume percent, or 10 to 75 volume percent, or 10 to 65 volume percent, or 15 to 55 volume percent, or 20 to 60 volume percent, or 20 to 55 volume percent, or 25 to 50 volume percent, or 30 to 50 volume percent, or 35 to 45 volume percent, or 10 to 50 volume percent, or 10 to 40 volume percent, or 10 to 35 volume percent, or 15 to 30 volume percent, or 20 to 30 volume percent, each based on the total volume of the composition.

The total amounts of the first solvent and the second solvent sum to at least 90 volume percent, or at least 92 volume percent, or at least 95 volume percent, or at least 97 volume percent, or at least 98 volume percent, or at least 99 volume percent. In an aspect, the total amounts of the first solvent, and the second solvent, sum to 100 volume percent.

In an aspect, the composition can be substantially free of certain solvents. As used herein, the term “substantially free” means that the composition includes less than or equal to 10 volume percent, or less than or equal to 5 volume percent, or less than or equal to 1 volume percent, or less than or equal to 0.5 volume percent, or less than or equal to 0.1 volume percent of the recited solvent. For example, in an aspect, the composition can be substantially free of N-methylpyrrolidone, tetrahydrofuran, or a combination thereof. In an aspect, the composition can exclude a particular solvent, for example the composition can exclude N-methylpyrrolidone, tetrahydrofuran, or a combination thereof (i.e., no N-methylpyrrolidone, tetrahydrofuran, or a combination thereof is present in the composition). In an aspect, the composition can exclude solvents other than benzaldehyde, 1,3-dioxolane, tetrahydropyran, 4-picoline, ethyl benzoate, methyl benzoate, cyclopentanone, cyclohexanone, cycloheptanone, acetone, acetyl acetone, methyl ethyl ketone, 2-pentanone, 3-pentanone/diethyl ketone, methyl acetate, dimethyl carbonate, tert-butyl acetate, propylene carbonate, PCBTF, ethyl acetate, 1,2-butylene oxide, anisole, dimethyl acetamide, pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, and dimethyl sulfoxide.

In an aspect, the composition comprises, based on the total volume of the composition, 40 to 80 volume percent of the first solvent, and 20 to 60 volume percent of the second solvent. In an aspect, the first solvent can be selected from tetrahydropyran, 4-picoline, benzaldehyde, 1,3-dioxolane, or a combination thereof, preferably tetrahydropyran, 1,3-dioxolane, or a combination thereof. In an aspect the second solvent can comprise cyclohexanone, acetone, methyl ethyl ketone, pyrrolidine, or a combination thereof.

In another aspect, the composition can comprise, based on the total volume of the composition, or 55 to 65 volume percent of the first solvent, and 35 to 45 volume percent of the second solvent. In an aspect, the first solvent can be selected from tetrahydropyran, 4-picoline, benzaldehyde, 1,3-dioxolane, or a combination thereof, preferably tetrahydropyran, 1,3-dioxolane, or a combination thereof. In an aspect the second solvent can comprise cyclohexanone, acetone, methyl ethyl ketone, pyrrolidine, or a combination thereof.

The composition of the present disclosure advantageously exhibits an improved environmental, health, and safety profile compared to other compositions, for example NMP- and THF-containing compositions commonly employed for adhesive compositions.

The composition can be prepared by mixing the components, for example, by blending using a mechanical mixer in a tank or other similar vessel.

Another aspect of the present disclosure is an adhesive formulation comprising the above-described composition. The adhesive formulation of the present disclosure can be particularly useful for bonding articles such as pipes, fittings, flanges, and the like, preferably wherein said articles are plastic (e.g., comprise a polymer composition). For example, an adhesive formulation can comprise a thermoplastic resin, such as a polyvinyl chloride, a chlorinated polyvinyl chloride, acrylonitrile-butadiene-styrene (ABS), and the like or a combination thereof, and the solvent composition described herein. For example, the adhesive formulation can comprise 1 to 25 volume percent, for example 5 to 15 volume percent, of the thermoplastic resin (e.g., polyvinyl chloride, the chlorinated polyvinyl chloride, ABS, and the like or a combination thereof), and 75 to 99 volume percent, for example 85 to 95 volume percent, of the solvent composition of the present disclosure. The adhesive formulation can also be referred to as a “cement”.

In an aspect, the composition can further comprise an additive. The additive(s) can be selected to achieve a desired property, with the proviso that the additive(s) are also selected so as to not significantly adversely affect a desired property of the composition. In an aspect, the additive can be selected from the group consisting of thickeners, wetting agents, colorants, rinsing agents, evaporation inhibitors, activators, corrosion inhibitors, surfactants, or other adhesive/primer type additives, and combinations thereof. In an aspect, the additive can preferably be selected from the group consisting of thickeners, colorants, fillers, and combinations thereof. Thickeners are generally used to increase the viscosity of the composition. Exemplary thickeners can include, for example, cellulose ethers (e.g., hydroxypropyl cellulose, ethyl cellulose, ethyl hydroxyethyl cellulose, methyl cellulose, and other alkyl or hydroxyalkyl cellulose, and combinations thereof); silica including colloidal silica; clays (e.g., bentonite and montmorillonite starch); alumina including colloidal alumina; gum arabic; tragacanth; agar; sugar derivatives; high molecular weight polyethylene oxides; fatty acid salts; guar gum; xanthan gum; polyvinyl pyrrolidone and methyl vinyl ether/maleic anhydride copolymers; paraffinic waves (e.g., polyethylene wax); and the like, or a combination thereof. Colorants can be used to provide color to the composition. Exemplary colorants can include, for example, pigments, dyes, or combinations thereof. Fillers can include, for example, particulate inorganic fillers. Suitable particulate inorganic fillers can include fine powders having an average particle size of less than 50 micrometers and a density of less than 4 g/ml. Examples can include, but are not limited to, quartz, talc, magnesium silicate, calcium carbonate, clay, whiting, shell flour, wood flour, alumina, antimony trioxide, asbestos powder, barium sulfate, calcined clays, China clays, magnesium oxide, and mica powder.

When present, the additive(s) can be included in the composition in an amount of greater than 0 to 10 weight percent, or 1 to 10 weight percent, or 2 to 5 weight percent, based on the total weight of the composition.

The adhesive formulation can be useful in a method of bonding plastic surfaces. Accordingly, a method of bonding a first plastic component to a second plastic component represents another aspect of the present disclosure. The method comprises applying the adhesive formulation to at least a portion of a surface of the first plastic component and/or the second component; and contacting the surface of the first plastic component with a surface of the second plastic component.

The first and second plastic components can be the same or different, and each can independently comprise, for example, PVC, CPVC, ABS, acrylic resins, vinyl aromatic polymers, vinyl pyrrolidone polymers, and the like or a combination thereof, and are preferably formed from the same material as the resin component in the cement formulation. Any objects that the user wishes to bond can function as the first and second plastic components. For example, the first component may be a piping component that includes a male end, and the second component may be a piping component that includes female end. However, the first and second components need not be piping components.

The step of applying the adhesive formulation to a surface of the first plastic component may be performed using any process. For example, the adhesive formulation may be applied to the surface of the first plastic component by pouring, sprinkling, dabbing, brushing, spattering, or spraying the solvent cement onto the plastic component. The volume of adhesive formulation that is applied to the first plastic component should be sufficient to permit bonding between the first and second plastic components and may readily be determined by those of ordinary skill in the art, depending on the nature of the first and second components, of the type of bond to be created, and the end use of the bonded components.

If desired, the present methods may also include applying the adhesive formulation to a surface of the second plastic component. Preferably, the surface of the second plastic component to which the adhesive formulation is applied represents at least a portion of the second plastic component that is contacted with a surface of the first plastic component, such as the surface of the first plastic component to which the adhesive formulation has also been applied.

In an aspect, the method can include applying a primer composition to the first and/or second plastic parts prior to applying the adhesive formulation. In an aspect, the primer composition can comprise the solvent composition of the present disclosure.

Thus, the present inventors have discovered new compositions comprising a particular combination of solvents that are particularly useful for adhesive formulations. The compositions of the present disclosure provide an improved environmental, health, and safety profile as compared to current compositions commonly used.

### EXAMPLES

The present inventors sought to identify an improved adhesive formulation without the use of tetrahydrofuran (a carcinogen). Solvents that are known to cause cancer or lead to other adverse health effects were removed from consideration. With this, approximately 9,000 solvents remained as potential alternatives to tetrahydrofuran.

The adhesive formulations of the present disclosure are solvent blends where the individual solvents can be included in the formulation at varying concentrations. This further increases the number of possible solutions to the technical problem at hand.

The solvent alternatives were ultimately narrowed to 1,3-dioxolane, benzaldehyde, tetrahydropyran, 4-picoline, ethyl benzoate, methyl benzoate, or a combination thereof. These results were not predictable because all six solvents are not found in any commercially available adhesive formulations. Further, five of the six solvents (benzaldehyde, tetrahydropyran, 4-picoline, ethyl benzoate, and methyl benzoate) are not found in any other commercially available adhesive products for any other bonding application and therefore were not obvious replacements and were only discovered as potential solvents for the adhesive formulations through an extensive scientific analysis and iterative testing process.

This iterative process included conducting bonding/lap shear strength testing, dissolution testing, evaporation testing, and formulation stability testing. Analysis of test results and observations of trends were necessary to determine certain target chemical properties such as the desired chemical structure, and the acceptable ranges of the three intermolecular forces: dispersion forces, polar dipole-dipole forces, and hydrogen bonding forces. This required deep knowledge of mechanical engineering for understanding bonding strength, chemistry for understanding the impacts of chemical structure and intermolecular forces, and chemical engineering for assessing formulation effectiveness and stability. Other considerations necessary for developing viable PVC formulations included the Volatile Organic Content (VOC) of the formulation, costs of the solvents, and compatibility with the PVC and CPVC substrates. The results of each test had to be analyzed to determine the solvents/solvent blends to be included in the next round of tests to be conducted.

The present examples further describe solvent selection and adhesive formulations according to the present disclosure.

### Relative Evaporation Rates

Absolute evaporation rate is the mass of material that evaporates from a surface per unit time (e.g., 3 grams per square meter per hour). Absolute evaporation rates generally have an inverse relationship to boiling points (i.e., the higher the boiling point, the lower the rate of evaporation). Absolute evaporation rates depend on many variables such as temperature, atmospheric pressure, humidity, air flow, viscosity, and the like. Relative evaporation rate (RER) is the rate at which a material will vaporize (evaporate or change from liquid to vapor) compared to the rate of vaporization of a specific known material. This quantity is a ratio, and therefore it is unit less.

The common reference solvent used for relative evaporation rates (RER) is n-butyl acetate (commonly abbreviated BuAc), where BuAc=100. Examples of solvents, and how their evaporation compares to BuAc are shown in Table 1.

TABLE 1

| | RER | |
|---|---|---|
| Evaporation Speed | (BuAc = 100) | Solvents |
| Fast | >300 | Hexane = 830 |
| Medium | 80 to 300 | Acetonitrile = 230 |
| Slow | <80 | Isobutyl Alcohol = 62 |

Solvents useful in the compositions of the present disclosure have the following relative evaporation rates, as shown in Table 2.

TABLE 2

| | RER | |
|---|---|---|
| Evaporation Speed | (BuAc = 100) | Solvents |
| Fast | >300 | Methyl acetate = 1,180 |
| | | Acetone = 560 |
| | | 1,3 dioxolane = 500 |
| | | Methyl ethyl ketone = 380 |
| | | Tetrahydropyran = 321 |
| Medium | 80 to 300 | 2 pentanone (MPK) = 240 |
| | | 3 pentanone (DEK) = 172 |
| Slow | <80 | Pyridine = 77 |
| | | 4-picoline = 50 |
| | | Cyclopentanone = 42 |
| | | Cyclohexanone = 29 |
| | | Benzaldehyde = 6 |
| | | Dimethyl sulfoxide (DMSO) = 3 |
| | | Methyl benzoate = 2 |
| | | Ethyl benzoate = 1 |

Accordingly, the solvents useful for the composition of the present disclosure cover the range of slow, medium, and fast relative evaporation rates, relative to BuAc. Therefore, the solvents used herein are examples of safer solvents which can also meet various evaporation rate requirements for specific product applications.

### Dissolution Testing

Dissolution testing was conducted to determine if the formulations of the present disclosure could meet the dissolution requirements of ASTM standard D-2564 for PVC solvent cements and ASTM standard F-493 for CPVC solvent cements. The dissolution tests involved dissolving 13% by weight of either CPVC or PVC resin within the solvent blend with no evidence of gelation. The amount of resin required for the 13% by weight was different for each solvent blend depending on the density and concentration of the solvents used in the solvent blend.

First, 10 ml of the solvent blend was added to a 20 ml glass vial. Next, a small amount (approximately 0.2 grams) of PVC or CPVC resin was added to the glass vial. The glass vial was placed on a tube roller that rotated the glass vial at 35 rpm. The glass vial was monitored for dissolution. Once the PVC or CPVC resin was fully dissolved, then another small amount (approximately 0.2 grams) of PVC or CPVC resin was added to the glass vial. This process was repeated until the entire 13% of PVC or CPVC resin was fully dissolved. The duration of the test was 6 hours. A successful test occurred when the entire 13% of PVC or CPVC resin was fully dissolved in less than 6 hours within the 10 ml of solvent.

Test results for dissolution of the PVC resin are shown below.

| | % Volume | Result |
|---|---|---|
| P1 | | |
| Tetrahydropyran | 60% | Pass |
| Cyclohexanone | 20% | |
| Acetone | 20% | |
| Total | 100% | |
| F1 | | |
| THF | 60% | Pass |
| Cyclohexanone | 20% | |
| Acetone | 20% | |
| Total | 100% | |
| N1 | | |
| NMP | 100% | Pass |
| Total | 100% | |
| T2 | | |
| Tetrahydropyran | 60% | Pass |
| Acetone | 40% | |
| Total | 100% | |
| TP3 | | |
| Tetrahydropyran | 30% | Pass |
| Cyclohexanone | 20% | |
| 4-picoline | 30% | |
| Acetone | 20% | |
| Total | 100% | |
| TB4 | | |
| Tetrahydropyran | 40% | Pass |
| Cyclohexanone | 20% | |
| Benzaldehyde | 20% | |
| Acetone | 20% | |
| Total | 100% | |
| MEK5 | | |
| MEK | 50% | Fail |
| Cyclohexanone | 25% | |
| Acetone | 25% | |
| Total | 100% | |
| MEKD7.5 | | |
| MEK | 75% | Fail |
| DMSO | 25% | |
| Total | 100% | |
| F5 | | |
| THF | 50% | Pass |
| MEK | 10% | |
| Cyclohexanone | 20% | |
| Acetone | 20% | |
| Total | 100% | |
| PD2 | | |
| 4-picoline | 40% | Pass |
| 1,3 dioxolane | 20% | |
| Cyclohexanone | 20% | |
| Acetone | 20% | |
| Total | 100% | |
| PYRD3 | | |
| Pyrrolidine | 30% | Fail |
| 1,3 dioxolane | 30% | |
| Cyclohexanone | 20% | |
| Acetone | 20% | |
| Total | 100% | |
| DT3 | | |
| 1,3 dioxolane | 30% | Pass |
| Tetrahydropyran | 30% | |
| Cyclohexanone | 20% | |
| Acetone | 20% | |
| Total | 100% | |
| DT3.5 | | |
| 1,3 dioxolane | 35% | Pass |
| Tetrahydropyran | 25% | |
| Cyclohexanone | 20% | |
| Acetone | 20% | |
| Total | 100% | |
| DT4 | | |
| 1,3 dioxolane | 40% | Pass |
| Tetrahydropyran | 20% | |
| Cyclohexanone | 20% | |
| Acetone | 20% | |
| Total | 100% | |
| DT4.5 | | |
| 1,3 dioxolane | 45% | Pass |
| Tetrahydropyran | 15% | |
| Cyclohexanone | 20% | |
| Acetone | 20% | |
| Total | 100% | |
| DT5 | | |
| 1,3 dioxolane | 50% | Pass |
| Tetrahydropyran | 10% | |
| Cyclohexanone | 20% | |
| Acetone | 20% | |
| Total | 100% | |
| TE4 | | |
| Tetrahydropyran | 40% | Pass |
| Cyclohexanone | 20% | |
| Ethyl benzoate | 20% | |
| Acetone | 20% | |
| Total | 100% | |
| PM5 | | |
| 4-picoline | 40% | Pass |
| Cyclohexanone | 20% | |
| Methyl benzoate | 20% | |
| Acetone | 20% | |
| Total | 100% | |

Test results for dissolution of the CPVC resin are shown below.

| | % Volume | Result |
|---|---|---|
| CT5 | | |
| Tetrahydropyran | 50% | Pass |
| Cyclohexanone | 15% | |
| MEK | 25% | |
| Acetone | 10% | |
| Total | 100% | |
| CF5 | | |
| THF | 50% | Pass |
| Cyclohexanone | 15% | |
| MEK | 25% | |
| Acetone | 10% | |
| Total | 100% | |
| CT6 | | |
| Tetrahydropyran | 60% | Fail |
| Acetone | 40% | |
| Total | 100% | |
| CF6 | | |
| Tetrahydrofuran | 60% | Fail |
| Acetone | 40% | |
| Total | 100% | |

### Lap Shear Testing

CPVC and PVC rigid plates were bonded with various adhesive formulations and tested for bonding strength. A single lap joint was loaded in tension. The rigid plate surfaces were first cleaned with methyl ethyl ketone (MEK). The lap shear test equipment used was the MTS Criterion Model 43. The shear speed used was 0.05 inches per minute. All PVC and CPVC cement formulations tested were made in the University of Massachusetts Lowell laboratory. The formulations contained solvent blends and dissolved PVC or CPVC resin.

The PVC lap shear strength test results are provided in Table 3.

TABLE 3

| | Load at Failure | Load at Failure |
|---|---|---|
| Solvent Ingredients | (2 hour cure) | (16 hour cure) |
| THF 50% | Number of test specimens: 4 | Number of test specimens: 4 |
| Acetone 20% | Range: 73.9-157.5 lbs | Range: 102.2-138.7 lbs |
| Cyclohexanone 20% | Average: 110.8 lbs | Average: 127.2 lbs |
| MEK 10% | | |
| 4 picoline 40% | Number of test specimens: 4 | Number of test specimens: 2 |
| 1,3 dioxolane 20% | Range: 79.6-171.4 lbs | Range: 118.7-200.3 lbs |
| Acetone 20% | Average: 130.5 lbs | Average: 159.5 lbs |
| Cyclohexanone 20% | | |
| 1,3 dioxolane 50% | Number of test specimens: 3 | Number of test specimens: 4 |
| Tetrahydropyran 10% | Range: 91.9-204.3 lbs | Range: 86.9-218.7 lbs |
| Acetone 20% | Average: 140.1 lbs | Average: 149.2 lbs |
| Cyclohexanone 20% | | |

The CPVC lap shear strength test results are provided in Table 4.

| | Load at Failure | Load at Failure |
|---|---|---|
| Solvent Ingredients | 2 hour cure | 16 hour cure |
| THF 50% | Number of test specimens: 4 | Number of test specimens: 2 |
| Acetone 10% | Range: 45.1-95.9 lbs | Range: 148.3-156.0 lbs |
| Cyclohexanone 15% | Average: 61.1 lbs | Average: 152.2 lbs |
| MEK 25% | | |
| 4 picoline 30% | Number of test specimens: 2 | Number of test specimens: 2 |
| 1,3 dioxolane 20% | Range: 113.4-147.9 lbs | Range: 156.5-178.7 lbs |
| Acetone 10% | Average: 130.7 lbs | Average: 167.6 lbs |
| Cyclohexanone 15% | | |
| MEK 25% | | |
| 1,3 dioxolane 20% | Number of test specimens: 2 | Number of test specimens: 2 |
| Tetrahydropyran 30% | Range: 109.7-120.5 lbs | Range: 128.7-172.6 lbs |
| Acetone 10% | Average: 115.1 lbs | Average: 150.7 lbs |
| Cyclohexanone 15% | | |
| MEK 25% | | |

As shown in Table 3 and 4, a higher average load at failure was attained for 16 hour cure versus 2 hour cure test specimens for all formulations and materials tested. Each of the formulations according to the present disclosure (i.e., not including THF) exhibited comparable (e.g., ±2 lbs) or better average load at failure as compared to the comparative formulation, representative of current PVC/CPVC commercial formulations containing THF.

Accordingly, a significant improvement in compositions for adhesive applications can be provided by the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). “Or” means “and/or”.

1. A composition comprising,
a first solvent selected from benzaldehyde, 1,3-dioxolane, tetrahydropyran, 4-picoline, ethyl benzoate, methyl benzoate, or a combination thereof;
a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof;
wherein the amounts of the first solvent, and the second solvent, sum to at least 90 volume percent.

2. The composition of claim 1, wherein the second solvent comprises a cyclic ketone or an aliphatic ketone selected from cyclopentanone, cyclohexanone, cycloheptanone, acetone, acetyl acetone, methyl ethyl ketone, 2-pentanone, 3-pentanone, or a combination thereof.

3. The composition of claim 1, wherein the second solvent comprises pyrollidine.

4. The composition of claim 1, comprising
40 to 80 volume percent of the first solvent, and
20 to 60 volume percent of the second solvent;

5. The composition of claim 1, comprising
55 to 65 volume percent of the first solvent, and
35 to 45 volume percent of the second solvent;.

6. A method for the manufacture of the composition of claim 1, the method comprising:
combining first solvent and the second solvent to provide the composition.

7. An adhesive formulation comprising:
1 to 25 volume percent, of a thermoplastic resin, and
75 to 99 volume percent of the composition of claim 1;
wherein volume percent is based on the total volume of the adhesive formulation.

8. The adhesive formulation of claim 7, further comprising an additive or additives.

9. A method for bonding a first plastic component to a second plastic component, the method comprising:
applying the adhesive formulation of claim 7 to at least a portion of a surface of the first and/or second plastic component; and
contacting the surface of the first plastic component with a surface of the second plastic component.

10. The method of claim 9, comprising applying a primer composition to at least a portion of a surface of the first plastic component, at least a portion of a surface of the second plastic component, or both prior to applying the adhesive formulation.

11. The method of claim 10, wherein the primer composition comprises, based on the total volume of the composition,
a first solvent selected from benzaldehyde, 1,3-dioxolane, tetrahydropyran, 4-picoline, ethyl benzoate, methyl benzoate, or a combination thereof;
a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof; wherein the amounts of the first solvent, and the second solvent, sum to at least 90 volume percent.

12. A method for bonding a first plastic component to a second plastic component, the method comprising:
applying a primer composition to at least a portion of a surface of the first plastic component, at least a portion of a surface of the second plastic component, or both, wherein the primer composition comprises, based on the total volume of the composition,
a first solvent selected from benzaldehyde, 1,3-dioxolane, tetrahydropyran, 4-picoline, ethyl benzoate, methyl benzoate, or a combination thereof;
a second solvent selected from cyclic ketones, aliphatic ketones, methyl acetate, dimethyl carbonate, tert-butyl acetate, propylene carbonate, PCBTF, ethyl acetate, 1,2-butylene oxide, anisole, dimethyl acetamide (DMA), pyridine, dimethyl maleate, dimethyl sulfide, triethyl phosphate, pyrrolidine, 1-vinyl-2-pyrrolidinone, 2-pyrrolidinone, thioacetic acid, N, N diethyl formamide, n-methyl pyrrole, 2-methyl pyrazine, ethyl iodide, dimethyl sulfoxide (DMSO), or a combination thereof; wherein the amounts of the first solvent, and the second solvent, sum to at least 90 volume percent;
applying an adhesive composition comprising a thermoplastic resin to at least a portion of a surface of the first plastic component, at least a portion of a surface of the second plastic component, or both; and
contacting the surface of the first plastic component with a surface of the second plastic component.
